(19) United States
(12) Patent Application Publication
(10) Pub. No.: US 2019/0203684 A1
(43) Pub. Date: Jul. 4, 2019

(54) High-Pressure Fuel Pump

(71) Applicant: Continental Automotive GmbH, Hannover (DE)

(72) Inventors: Yury Mikhaylov, Landshut (DE); Yavuz Kurt, Roding (DE)

(73) Assignee: Continental Automotive GmbH, Hannover (DE)

(21) Appl. No.: 16/238,904

(22) Filed: Jan. 3, 2019

(30) Foreign Application Priority Data
Jan. 4, 2018 (DE) 10 2018 200 083.2

(51) Int. Cl. F02M 59/34; F02M 37/00; F02M 59/44; F02M 59/02; F04B 37/12; F04B 53/00

(52) U.S. Cl. CPC F02M 59/34; F02M 37/0041; F02M 59/44; F02M 2200/315; F04B 37/12; F04B 53/002; F02M 2200/16; F02M 59/025

(57) ABSTRACT

Various embodiments include a high-pressure fuel pump for a fuel injection system of an internal combustion engine comprising: a rigid housing defining a pressure chamber; a low-pressure region for feeding fuel to the pressure chamber; a sealing element delimiting the low-pressure region in conjunction with the rigid housing, wherein the low-pressure region has a variable volume; wherein the sealing element deflects from a rest position to vary the volume of the low-pressure region and seals off the low-pressure region from surroundings; and a controllable adjusting element operable to deflect the sealing element to control the volume in the low-pressure region.

### CROSS-REFERENCE TO RELATED APPLICATIONS

This application claims priority to DE Application No. 10 2018 200 083.2 filed Jan. 4, 2018, the contents of which are hereby incorporated by reference in their entirety.

### TECHNICAL FIELD

The present disclosure relates to internal combustion engines. Various embodiments may include a high-pressure fuel pump for applying high pressure to a fuel in a fuel injection system of an internal combustion engine.

### BACKGROUND

High-pressure fuel pumps are used, in fuel injection systems by means of which fuel is injected into combustion chambers of an internal combustion engine, to apply a high pressure to the fuel, wherein the pressure lies for example in a range from 150 bar to 400 bar in gasoline internal combustion engines and in a range from 1500 bar to 2500 bar in diesel internal combustion engines. The higher the pressure which can be generated in the respective fuel, the lower the emissions which arise during the combustion of the fuel in the combustion chamber, this being advantageous in particular against the background of a reduction in emissions being desired to an ever greater extent.

To achieve the high pressures in the respective fuel, the high-pressure fuel pump is typically embodied as a piston pump, wherein a pump piston performs a translational movement and in so doing periodically compresses and relieves the pressure on the fuel. The thus non-uniform delivery of such a piston pump leads to fluctuations in the volume flow in a low-pressure region of the high-pressure fuel pump, which fluctuations are associated with pressure fluctuations in the entire fuel injection system. As a consequence of these fluctuations, filling losses can occur in the high-pressure fuel pump, as a result of which correct dosing of the fuel quantity required in the combustion chamber cannot be ensured. The pressure pulsations that arise furthermore cause pump components, and for example feed lines to the high-pressure fuel pump, to vibrate, which vibrations can cause undesired noises or, in the worst case, even damage to various parts.

A damper arrangement is therefore normally provided in the low-pressure region of the high-pressure fuel pump, which damper arrangement operates as a hydraulic accumulator and evens out the fluctuations in the volume flow and thus reduces the pressure pulsations that arise. For this purpose, it is for example the case that deformable elements are installed, which separate a gas volume from fuel. If the pressure in the low-pressure region of the high-pressure fuel pump increases, said elements deform, wherein, for example, the gas volume is compressed and space is created for the superfluous liquid of the fuel. If the pressure falls again at a later point in time, the gas expands again, and the stored liquid of the fuel is thus released again.

It has hitherto been known for so-called damper capsules to be used as deformable elements, which damper capsules are normally constructed from two diaphragm parts which are filled with gas and welded at the edges. Said damper capsules can deform by virtue of the gas contained therein being compressed and can thus passively dampen the pressure pulsations.

### SUMMARY

The teachings herein describe an improved high-pressure fuel pump. For example, some embodiments of the teachings may include a high-pressure fuel pump (10) for applying high pressure to a fuel in a fuel injection system of an internal combustion engine, having: a low-pressure region (20) for feeding fuel to a pressure chamber (14) of the high-pressure fuel pump (10), wherein the low-pressure region (20) has a variable volume (30) and is delimited by a rigid housing (12) of the high-pressure fuel pump (10) and by a sealing element (28) which, in order to vary the volume (30) in the low-pressure region (20), is deflectable out of a rest position and which serves for sealing off the low-pressure region (20) with respect to surroundings (32); and a controllable adjusting element (38) which interacts with the sealing element (28) for the purposes of deflecting the sealing element (28) in order to control the volume (30) in the low-pressure region (20) in accordance with demand.

In some embodiments, the adjusting element (38) is arranged such that, when actuated, the volume (30) of the low-pressure region (20) increases in size.

In some embodiments, the sealing element (28) is formed as a plate-like element and is fastened to the housing (12), wherein the sealing element (28) is formed as an elastically deformable diaphragm (34), or wherein the sealing element (28) is formed as a rigid plate (56) which is fastened to the housing (12) by means of elastic mounting elements (58).

In some embodiments, the adjusting element (38) is formed as an electrically actuatable actuator (40), in particular as an electromagnetic actuator (42) or as a piezo actuator (44).

In some embodiments, between the actuator (40) and sealing element (28), there is arranged a lever element (46) for increasing a stroke of the actuator (40).

In some embodiments, the adjusting element (38) is connected to a control device (48) which, in a manner dependent on an operating point (B) of the high-pressure fuel pump (10), adjusts deflection parameters of the sealing element (28), in particular a time of actuation of the adjusting element (38) and/or a frequency of the actuation of the adjusting element (38) and/or a stroke of the adjusting element (38).

In some embodiments, a sensor (50) which communicates with the control device (48) is provided for detecting a pressure in the low-pressure region (20), and/or in that the control device (48) is designed to calculate deflection parameters in a manner dependent on an operating point (B) of the high-pressure fuel pump (10), and/or in that, in the control device (48), there is stored a characteristic map (54) which assigns predefined deflection parameters to an operating point (B) of the high-pressure fuel pump (10).

### BRIEF DESCRIPTION OF THE DRAWINGS

Various example design embodiments of the teachings herein are explained in more detail below by means of the appended drawings, in which:

FIG. 1 shows a longitudinal sectional illustration of a high-pressure fuel pump with a deflectable sealing element incorporating teachings of the present disclosure, which sealing element is acted on by a controllable adjusting element; and

FIG. 2 is a longitudinal sectional illustration of a high-pressure fuel pump with a deflectable sealing element incorporating teachings of the present disclosure, which sealing element is acted on by a controllable adjusting element.

### DETAILED DESCRIPTION

In some embodiments, a high-pressure fuel pump for applying high pressure to a fuel in a fuel injection system of an internal combustion engine has a low-pressure region for feeding fuel to a pressure chamber of the high-pressure fuel pump, wherein the low-pressure region has a variable volume and is delimited by a rigid housing of the high-pressure fuel pump and by a sealing element which, in order to vary the volume in the low-pressure region, is deflectable out of a rest position and which serves for sealing off the low-pressure region with respect to surroundings. Furthermore, the high-pressure fuel pump has a controllable adjusting element which interacts with the sealing element for the purposes of deflecting the sealing element in order to control the volume in the low-pressure region in accordance with demand. The concept therein creates a change in volume or a volume compensation by means of an actively actuated mechanism rather than by means of the hitherto known passive damper capsules.

In some embodiments, the adjusting element is arranged such that, when actuated, the volume of the low-pressure region increases in size. In this way, an equalization is realized in relation to a volume enlargement associated with pressure pulsations in the low-pressure region. The low-pressure region is not exclusively delimited by the rigid housing and the deflectable sealing element, but rather further elements, such as for example a valve element and an inflow connector, which jointly form the low-pressure region are also present.

In some embodiments, the sealing element comprises a plate-like element fastened to the housing, wherein, in some embodiments, the sealing element comprises an elastically deformable diaphragm. In some embodiments, the sealing element comprises a rigid plate, which is fastened by means of elastic mounting elements to the housing. The low-pressure region of the high-pressure fuel pump can therefore be sealed off with respect to the surroundings either by a deformable element or by a rigid element which is connected to a deformable element.

In some embodiments, the adjusting element comprises an electrically actuatable actuator, in particular as an electromagnetic actuator or as a piezo actuator. The change in volume or volume compensation can thus be realized by means of an electrically actuated mechanism. Both the use of an electromechanically operated valve and the use of a piezo actuator are conceivable here. An embodiment including a piezo actuator may provide a very short switching time, that is to say this actuator can react very quickly and thus be actuated or activated more often in a defined time. In the case of a corresponding design of the adjusting element for example as a piezo actuator, a change in volume or volume compensation can be realized in a very short time. For example, when a corresponding voltage is applied, a piezo actuator can exert very high forces on the sealing element.

In some embodiments, the sealing element may be deflected along an adjustment axis of the actuator. In some embodiments, the actuator is arranged such that, in the activated state, it presses against a central region of the sealing element and thus deflects the latter. The actuator can thus for example impart a stroke to the diaphragm or the rigid plate from a surroundings side in order to thus elastically deform the diaphragm or move the rigid plate, and thus vary the hydraulic volume. In some embodiments, the actuator may be pressed from the side of the low-pressure region against the diaphragm or the plate in order to thus targetedly vary the hydraulic volume.

In some embodiments, the adjusting element is fixedly connected to the sealing element and can, for example by means of a contraction, exert a pulling force on the sealing element and thus deflect the latter. The combination of sealing element and adjusting element may be used not only for compensating pressure pulsations caused by the operation of the high-pressure fuel pump during the pump stroke but also for ensuring adequate filling of the piston chamber during a suction phase during the operation of the high-pressure fuel pump. This is normally ensured by means of an adequately high predelivery pressure. In some embodiments, by means of the adjusting element, the pump generates a pressure pulse at a targeted point in time during the suction phase, which pressure pulse assists the filling of the pressure chamber.

In some embodiments, between the actuator and sealing element, there is arranged a lever element for increasing a stroke of the actuator. The stroke of the actuator can thus be imparted to the sealing element either by the actuator directly or by means of an additional mechanism in the form of a lever element. In some embodiments, the adjusting element may be connected to a control device which, in a manner dependent on an operating point of the high-pressure fuel pump, adjusts deflection parameters of the sealing element, in particular a time of actuation of the adjusting element and/or a frequency of the actuation adjusting element and/or a stroke of the adjusting element.

An operating point of the high-pressure fuel pump can, on the one hand, be understood to mean a load point of the internal combustion engine, which is determined for example by a rotational speed, temperature and a predelivery pressure of the fuel. This can however also be understood to mean a pressure, in the form of pressure pulsations, in the low-pressure region resulting from the operation of the high-pressure fuel pump. In a manner dependent on such an operating point and the resulting pressure pulsations within the high-pressure fuel pump, it is possible for a defined stroke and thus a defined change in volume in the low-pressure region of the high-pressure fuel pump to be performed by means of the adjusting element in order to thus keep the pressure pulsations within the high-pressure fuel pump as small as possible.

Here, in a manner dependent on the operating point, the adjusting element can be activated at different times of actuation or with different frequencies and different strokes. For this purpose, the adjusting element is advantageously connected to a control device which controls the actuation time, the frequency and the stroke of the adjusting element. It is for example possible for a control unit already present in the internal combustion engine, such as for example the ECU, to be used as control device.

In some embodiments, a sensor which communicates with the control device is provided for detecting a pressure in the low-pressure region. Here, the occurring pressure pulsations can be measured within or a short distance upstream of the high-pressure fuel pump by means of the sensor and communicated to the control device. On the basis of the detected pressure of the pressure pulsations, it is then possible for the control device to output a corresponding signal for deflecting the sealing element by means of the adjusting element.

In some embodiments, the control device is designed to calculate deflection parameters in a manner dependent on an operating point of the high-pressure fuel pump. If, in this case, operating point parameters such as for example a rotational speed of the internal combustion engine, a fuel temperature or a predelivery pressure are supplied to the control device, the control device can calculate the required deflection parameters of the sealing element and thus the stroke of the adjusting element and output a corresponding signal to the adjusting element.

In some embodiments, a characteristic map is stored in the control device, which characteristic map assigns predefined deflection parameters to an operating point of the high-pressure fuel pump. Here, the required deflection parameters such as for example the frequency and the stroke are worked out as a function of the operating point in advance by means of tests, and this mapping is stored. The control device thus selects the required deflection parameters from the characteristic map at the corresponding operating point, and outputs a corresponding signal to the adjusting element.

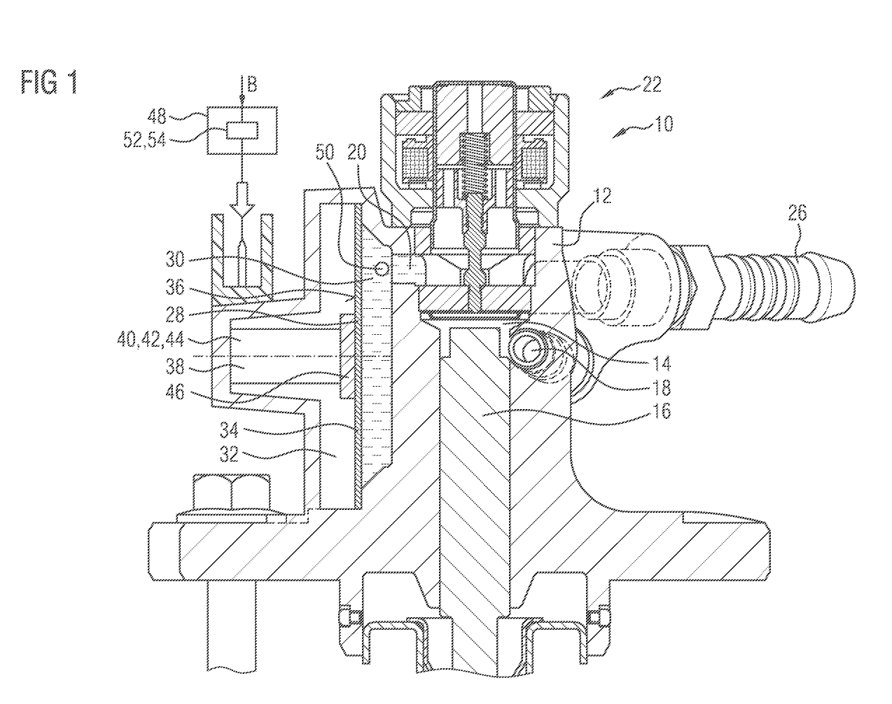

FIG. 1 shows a longitudinal sectional illustration of a first embodiment of a high-pressure fuel pump 10 having a housing 12 in which a pressure chamber 14 is formed. In the housing 12, there is guided a pump piston 16 which, by translational movement, periodically increases and decreases a volume of the pressure chamber 14. Here, high pressure is applied to fuel arranged in the pressure chamber 14. The highly pressurized fuel is then conducted via a high-pressure connector 18 to elements positioned downstream of the high-pressure fuel pump 10.

The fuel is fed to the pressure chamber 14 from a low-pressure region 20 of the high-pressure fuel pump 10. A valve arrangement 22 separates the pressure chamber 14 in the closed state from the low-pressure region 20. The low-pressure region 20 is delimited by the housing 12 of the high-pressure fuel pump 10, by the valve arrangement 22 and by a feed line 26, via which fuel is fed to the high-pressure fuel pump 10 from outside. Furthermore, a sealing element 28 delimits the low-pressure region 20, wherein the sealing element 28 is designed to be flexible or deflectable such that a volume 30 of the low-pressure region 20 is variable.

During operation, the pump piston 16 moves up and down in translational fashion in the pressure chamber 14, which leads to pressure pulsations in the fuel, which propagate in the low-pressure region 20. The propagation of such pressure pulsations in the low-pressure region 20 is however undesirable, because this causes components of the high-pressure fuel pump 10 such as for example the feed line 26 to vibrate, which can firstly give rise to undesired noises and secondly also lead to damage to the high-pressure fuel pump 10.

For this reason, the volume 30 of the low-pressure region 20 is provided so as to be variable by virtue of a deflectable sealing element 28 being provided for at least partially sealing off the low-pressure region 20 with respect to surroundings 32. In the present embodiment in FIG. 1, the sealing element 28 is formed as an elastically deformable diaphragm 34 and can thus, owing to its material characteristics, deform in the event of pressure pulsations occurring.

On an outer side 36 of the diaphragm 34, that is to say on a side averted from the low-pressure region 20, there is an adjusting element 38 which interacts with the sealing element 28 such that, as a result of an actuation, said adjusting element deflects the sealing element 28 in order to thus vary the volume 30 in the low-pressure region 20. In the present embodiment, the adjusting element 38 is arranged such that, in the event of an actuation, said adjusting element deforms the diaphragm 34 into the low-pressure region 20 and thus reduces the size of the volume 30. The adjusting element 38 is actively activatable, such that it is possible by means of the adjusting element 38 to control the size of the volume 30 in an active manner and in particular in accordance with demand.

The adjusting element 38 comprises an electrically actuatable actuator 40 and can thus be actively actuated through simple electrical activation. In some embodiments, the actuator 40 comprises an electromagnetic actuator 42, though it is also conceivable for the actuator 40 to be designed as a piezo actuator 44. In the present embodiment, a lever element 46 is arranged between actuator 40 and sealing element 28, which lever element can mechanically increase a stroke of the actuator 40.

The adjusting element 38 is connected to a control device 48, which outputs signals for actuating the adjusting element 38. Here, the control device 48 can, through correspondingly outputting signals, influence a time of actuation of the adjusting element 38, a frequency of the actuation of the adjusting element 38 and a stroke of the adjusting element 38 as deflection parameters of the adjusting element 38.

The control device 48 does this in a manner dependent on an operating point B of the high-pressure fuel pump 10, which is fed to the control device 48 from outside. Here, the operating point B may reflect a pressure detected in the low-pressure region 20 by a sensor 50 which is arranged in the low-pressure region 20, though it is also possible for further operating parameters B, such as for example a rotational speed, temperature or a predelivery pressure, to be fed into the control device 48.

In a manner dependent on the operating point B, the control device 48 can then decide which deflection parameters it outputs to the adjusting element 38. In some embodiments, the control device 48 is designed to calculate the deflection parameters in a manner dependent on the operating point B by means of a calculation unit 52. In one possible alternative embodiment, a characteristic map 54 is stored in the control device 48, which characteristic map has been worked out in advance by means of tests and assigns predefined deflection parameters to a particular operating point B. The control device 48 then reads out the predefined deflection parameters and transmits the corresponding signal to the adjusting element 38 for the deflection thereof.

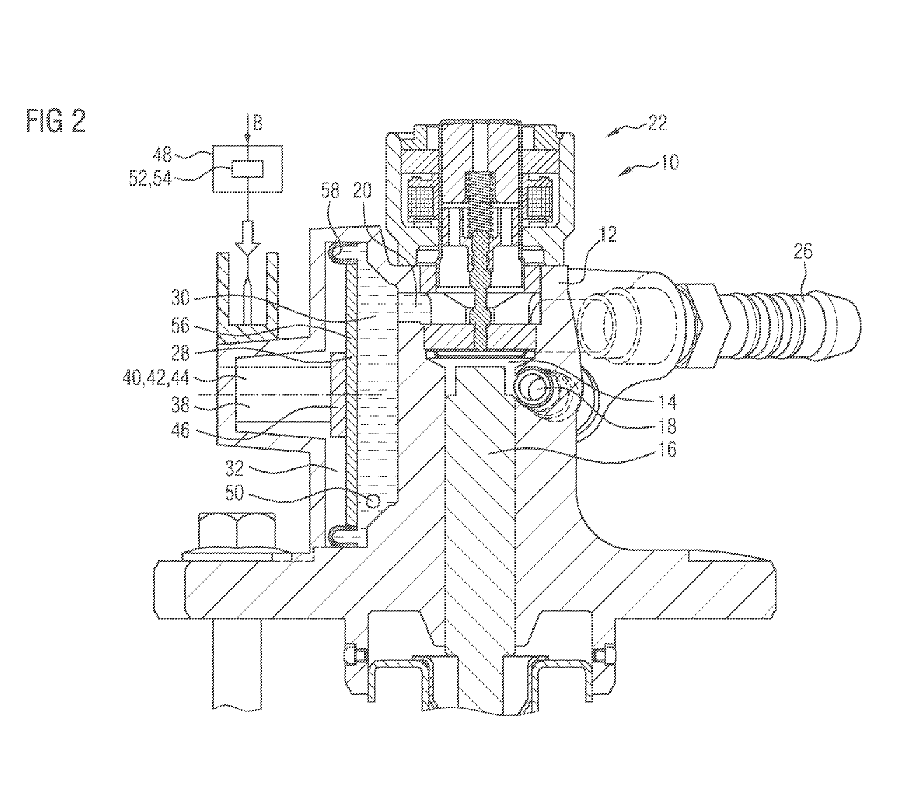

FIG. 2 shows a longitudinal sectional illustration of a second embodiment of the high-pressure fuel pump 10, wherein the second embodiment differs from the first embodiment merely in the design of the sealing element 28. In this second embodiment, the sealing element 28 is designed not as an elastically deformable diaphragm 34 but as a rigid plate 56, which is fastened by means of elastic mounting elements 58 to a housing 12. The deflection of the sealing element 28 in accordance with the second embodiment is therefore performed not by elastic deformation of the material of the sealing element 28 itself but by deformation of only the mounting elements 58, wherein the plate 56 remains as a rigid plate 56.

1. A high-pressure fuel pump for a fuel injection system of an internal combustion engine, the pump comprising:
a rigid housing defining a pressure chamber;
a low-pressure region for feeding fuel to the pressure chamber;
a sealing element delimiting the low-pressure region in conjunction with the rigid housing, wherein the low-pressure region has a variable volume;
wherein the sealing element deflects from a rest position to vary the volume of the low-pressure region and seals off the low-pressure region from surroundings; and
a controllable adjusting element operable to deflect the sealing element to control the volume in the low-pressure region.

2. The high-pressure fuel pump as claimed in claim 1, wherein activating the adjusting element increases the volume of the low-pressure region.

3. The high-pressure fuel pump as claimed in claim 1, wherein the sealing element comprises:
a plate-like element fastened to the rigid housing; and
an elastically deformable diaphragm.

4. The high-pressure fuel pump as claimed in claim 1, wherein the adjusting element comprises an electrically actuatable actuator.

5. The high-pressure fuel pump as claimed in claim 1, further comprising a lever arranged between the adjusting element and the sealing element for increasing a stroke of the adjusting element.

6. The high-pressure fuel pump as claimed in claim 1, wherein the adjusting element is connected to a control device which, in a manner dependent on an operating point (B) of the high-pressure fuel pump, adjusts deflection parameters of the sealing element.

7. The high-pressure fuel pump as claimed in claim 6, further comprising a sensor communicating with the control device for detecting a pressure in the low-pressure region.
and/or in that the control device (48) is designed to calculate deflection parameters in a manner dependent on an operating point (B) of the high-pressure fuel pump (10), and/or in that, in the control device (48), there is stored a characteristic map (54) which assigns predefined deflection parameters to an operating point (B) of the high-pressure fuel pump (10).

8. The high-pressure fuel pump as claimed in claim 1, wherein the sealing element comprises a rigid plate fastened to the rigid housing with elastic mounting elements.

9. The high-pressure fuel pump as claimed in claim 1, wherein the adjusting element is connected to a control device which, in a manner dependent on an operating point (B) of the high-pressure fuel pump, adjusts a time of actuation of the adjusting element and/or a frequency of the actuation of the adjusting element and/or a stroke of the adjusting element.

10. The high-pressure fuel pump as claimed in claim 6, wherein the control device calculates deflection parameters in a manner dependent on an operating point (B) of the high-pressure fuel pump.

11. The high-pressure fuel pump as claimed in claim 6, wherein the control device stores a characteristic map which assigns predefined deflection parameters to an operating point (B) of the high-pressure fuel pump.
